(19) United States
(12) Patent Application Publication
(10) Pub. No.: US 2009/0151447 A1
(43) Pub. Date: Jun. 18, 2009

(54) LIQUID LEVEL DETECTION IN AN EMANATING DEVICE

(75) Inventors: Wu Jin, Hull (GB); Paul Newton, Hull (GB); Simon Pugh, Hull (GB)

Correspondence Address: NORRIS, MCLAUGHLIN & MARCUS, 875 THIRD AVE, 18TH FLOOR, NEW YORK, NY, 10022, US

(73) Assignee: RECKITT BENCKISER (UK) LIMITED, SLOUGH-BERKSHIRE (GB)

(21) Appl. No.: 12/302,596

(22) PCT Filed: May 14, 2007
(86) PCT No.: PCT/GB07/01762

§ 371 Date: Feb. 10, 2009

(30) Foreign Application Priority Data
Jun. 1, 2006 (GB) 0610741.1

(51) Int. Cl. G01F 23/292

(52) U.S. Cl. 73/293

(57) ABSTRACT

An emanation device comprises an emanation material container (10), an emanation section (20) and emanation material level indication means (14,16); wherein, the emanation material level indication means (14, 16) comprises a light source (14), a light detector (16) and control means (not shown), wherein the light detector (16) is adapted to receive light from the light source (14) when a level of emanation material in the emanation material container (10) is at a first level and wherein the light detector (16) is adapted to receive substantially no light from the light source (14) when a level of emanation material in the emanation material container (10) is at a second level.

This invention relates to methods and systems for detecting an amount of material in a container or an empty condition of a container, particularly, but not limited to, the detection of an amount of material remaining in a container of a material ejection device.

Spray devices and emanators, such as fragrance sprays and sanitising material sprays are often electrically powered and may have a timer to determine when the spray device is activated. For example, the spray device may be activated periodically, at intervals of, for example, 5 or 10 minutes. In such devices, the spray material is held in a container for ejection by the spraying device. Alternatively a fragrance may be emanated from a container, by means of a heating collar located at an upper end of a wick that extends into the container. The heater causes evaporation of fragrance that is drawn up the wick by capillary action.

Sooner or later the container will become empty, when the material has been sprayed or emanated.

Some spray devices and emanators are constructed in such a way that it is difficult to see the contents of the container, for example if the container is opaque, or the container is hidden within the device. In such a situation it is difficult to determine whether the container is empty or the device has malfunctioned.

It is an object of the present invention to address these disadvantages.

According to a first aspect of the present invention there is provided an emanation device having an emanation material container, an emanation section and emanation material level indication means; wherein,
the emanation material level indication means comprises a light source, a light detector and control means,
wherein the light detector is adapted to receive light from the light source when a level of emanation material in the emanation material container is at a first level and wherein the light detector is adapted to receive substantially no light from the light source when a level of emanation material in the emanation material container is at a second level.

Preferably, the first level is a level of the emanation material below a sensing level, which sensing level is preferably at or close to an empty level. The empty level may be a nominal empty level below which the emanation material level indication means is not operable to detect.

Preferably, the second level is a level of the emanation material substantially at or above a sensing level, which sensing level is preferably at or close to an empty level.

Consequently, the light detector is preferably adapted to receive light when either no emanation material container is present in the device or the level of emanation material in the container is below a detection level.

Preferably, the light source is an LED, which may be an IR LED.

The light detector may be a photodiode or a photoresistor. Preferably, the light source is adapted to direct light at the emanation material container at an angle that is substantially at or between:
a) a critical angle of incidence for an interface between the emanation material and the emanation material container; and
b) a critical angle of incidence for an interface between air and the emanation material container.

The critical angle is preferably a critical angle for total internal reflection.

Preferably, the sensor is located to receive light from the light source that has entered the emanation material container and has been reflected from the interface between the emanation material container and air in the container.

The material container may incorporate a rib in a wall thereof, which rib may extend in a generally vertical direction. The rib may extend towards an opening of the material container.

The light source is preferably adapted to direct light towards the rib.

In an alternative embodiment, the sensor may be located to receive light from the light source that has entered the emanation material container and has been refracted at the interface between the emanation material container and air in the container. In this embodiment, the sensor is preferably arranged in relation to the light source such that light is refracted away from the detector when emanation material in the container is present at a detection level. The light source may be directed towards a curved face of the container.

The light detector may be directed to the curved face.

The light source and light detector are preferably in line-of-sight of one another, in order to allow light detection when no emanation material container is present.

The control means may be operable to control a light or lights of the emanation device. The control means may be operable to control a heater of the emanation device.

In another embodiment the emanation device may include a temperature sensor, which may be adapted to sense a temperature of a wick of the emanation device, which wick is adapted to transport emanation material from the emanation material container to the emanation section.

The temperature sensor is preferably operable, which may be operable in conjunction with the control means, to sense a difference in temperature that occurs when there is insufficient emanation material in the emanation material container for the wick to transport the emanation material to the emanation section. The temperature sensor is preferably operable to sense a difference in temperature of the wick between a wet condition of the wick and a dry condition thereof. Preferably, the wet condition occurs when there is sufficient emanation material present to allow transport thereof by capillary action to the emanation section. Preferably, the dry condition occurs when there is insufficient emanation material present to allow transport thereof by capillary action to the emanation section.

The temperature sensor may be located above a heater of the emanation device. The temperature sensor may be located in the vicinity of the wick. The temperature sensor may be located in a chimney section of the emanation section.

The control means may be operable to store a temperature of the wick in a memory section. The stored temperature may be a temperature of the wick in the wet condition. The control means may be operable to detect a deviation from the stored temperature, which deviation may be below a predetermined threshold value.

The control means may be operable to control a light or lights of the emanation device. The control means may be operable to control a heater of the emanation device.

According to another embodiment, the emanation device may include weight sensing means.

Preferably, the weight sensing means are operable to sense weight, or a change in weight, of the emanation material container, preferably by inference, an amount, or change in amount, of emanation material in the emanation material container is thereby determined.

The weight sensing means may include at least one strain gauge, preferably two strain gauges. The or each strain gauge may be located on a support arm for the emanation material container.

Where two strain gauges are provided, they may be connected in a Wheatstone bridge circuit. Preferably, the or each strain gauge is electrically connected to the control means.

Preferably, the control means is operable to receive signals from the weight sensing means.

The weight sensing means may incorporate a material having a variable electrical resistivity dependent on a strain applied to the material. The material may be a Quantum Tunnelling Composite (QTC).

Preferably, the control means is adapted to detect an end-of-life of the emanation material container when the weight of the emanation material container (and any emanation material therein) has fallen below a threshold level. The control means may be operable to prevent power being supplied to the emanation section, or to cause a visual and/or audible indication of the emanation material container being empty and/or close to an empty condition.

In another embodiment, the emanation device may include a counting element, which is operable to count a life span of the emanation device based on use thereof.

The counting element may count to a preset time limit when the emanation device is receiving power for emanation of the emanation material. The counting element may store a value of current count when power for emanation ceases. The value may be stored in a memory device, such as a non-volatile memory, such as an EEPROM.

The counting element may be actuable by a user to commence a count time, preferably when the emanation device is first used.

The invention extends to an emanation material container adapted to be used with an emanation section and emanation material level indication means of an emanation device as described above.

According to another aspect of the present invention there is provided an emanation device having an emanation material container, an emanation section and emanation material level indication means; wherein,
the emanation material level indication means comprises a temperature sensor, which may be adapted to sense a temperature of a wick of the emanation device, which wick is adapted to transport emanation material from the emanation material container to the emanation section.

According to another aspect of the present invention there is provided an emanation device having an emanation material container, an emanation section and emanation material level indication means; wherein, the emanation material level indication means comprises a weight sensing means adapted to measure a weight or change in weight of emanation material in the emanation material container.

All of the features described herein may be combined with any of the above aspects, in any combination.

For a better understanding of the invention, and to show how embodiments of the same may be carried into effect, reference will now be made, by way of example, to the accompanying diagrammatic drawings in which:

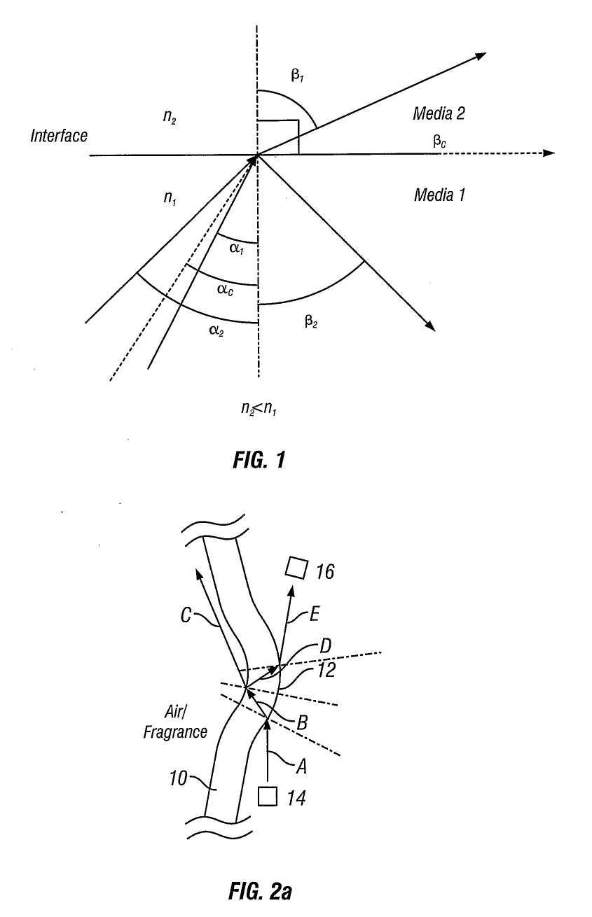

FIG. 1 is a schematic representation illustrating the concept of total internal reflection;

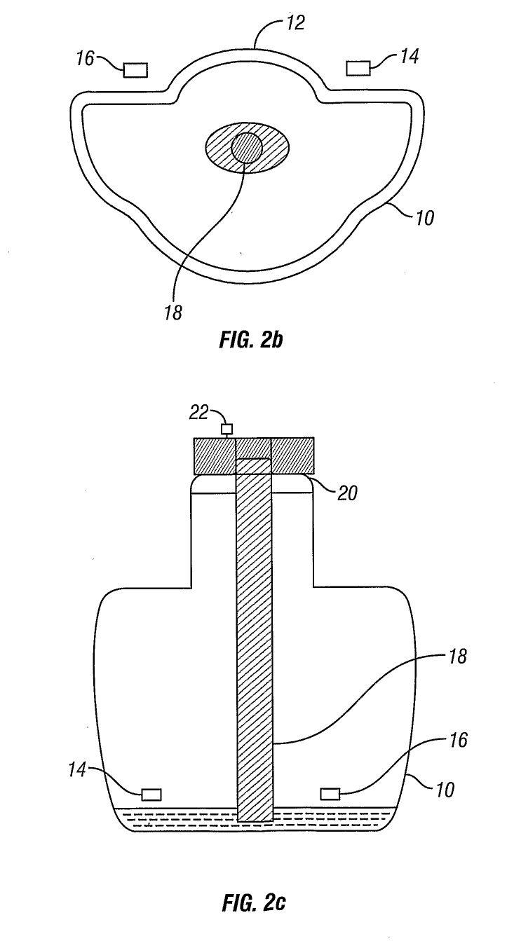

FIG. 2a is a schematic diagram showing a system for determining whether a container has reached an empty state;

FIG. 2b is a schematic cross-sectional plan view of the system of FIG. 2a;

FIG. 2c is a schematic cross-sectional front view of the system of FIG. 2b;

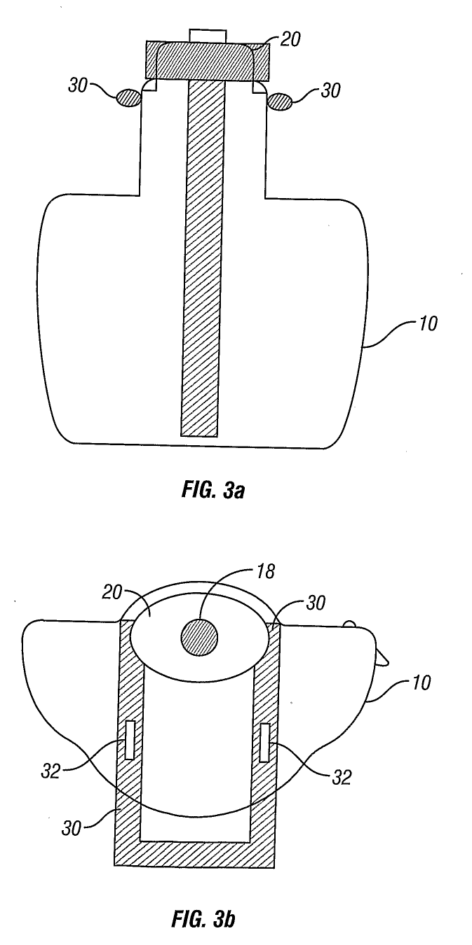

FIGS. 3a and 3b are schematic front and plan views of a container using a weight-based end-of-life indicator; and

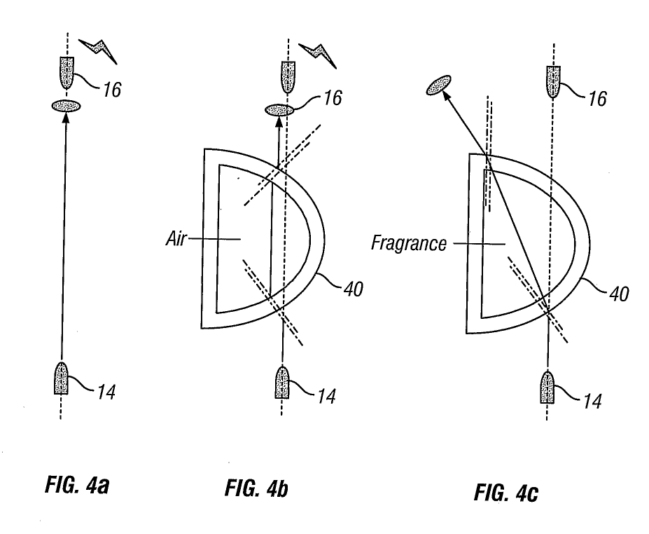

FIGS. 4a to 4c show schematic plan views of a system incorporating a refraction-based end-of-life detection method.

The detection of how much fluid remains in a container, or whether the container is empty or not, is of value in relation to spray devices and emanators in which the container holding the material is not visible in normal use. Consequently, a number of methods will be described below that allow either a determination of a level of material remaining, in a container, or a determination of whether the container is effectively empty. These methods can be used either alone, or in combination. When used in combination, greater accuracy may result.

A first method of detecting whether a level of material in a container is below a set level, which may be “nearly empty” level, is to use the principal of total internal reflection. Total reflection is a well known physical phenomenon, in which a beam of light passing through an interface between a first medium and a second medium having different refractive indices is either refracted or totally reflected. Depending on the angle of incidence of the beam of light at the interface, the beam may be either reflected back into the first medium, or may be refracted through the interface and into the second medium. If the light comes to a less dense medium (e.g. air) from a denser medium (e.g. glass), the light will not reach the less dense medium at all (i.e. it will be totally reflected) if the incidence angle of the light is greater than a critical value. An illustration is given in FIG. 1 to show the three situations when a beam of light enters from a denser medium (medium 1) to a less dense one (medium 2).

In FIG. 1, α indicates the angle of the incident light from a line perpendicular to the interface between the two media. β indicates the angle of the exiting light. The subscripts 1, 2 and c represent light with incident angles α₁, α₂, and a critical angle, α_{c}, respectively, with α₁<α_{c}<α₂. When the incidence angle equals the critical angle α_{c}, the light travels along the interface and β_{c}=90° (as shown by the dashed line running along the interface on the right hand side of FIG. 1). When the angle is smaller than the critical angle, i.e. for α₁, the light, although deflected by refraction can still enter the less dense medium, and β₁>α₁. When the angle of incidence is greater than α_{c}, i.e. α₂, the light can no longer enter the less dense medium and so is totally internally reflected back to the denser medium from the interface, so that β₂<α₂.

The total internal reflection principle can be used for empty bottle detection, when a light emitter-sensor pair and the refill bottle are configured as shown in FIG. 2.

In FIG. 2a a plan view of part of a glass wall 10 of a fragrance container (shown completely in FIGS. 2b and 2c) is shown. The wall 10 has a bulge 12, which is used for the total internal reflection detection method. The interior of the container is to the left hand side in FIG. 2a, with the exterior being to the right hand side outside the wall 10. An emitter 14, which may be an LED, such as a small emission angle LED, which could emit infrared or visible light is located outside the container. The emitter is arranged to send a beam of light (shown by arrow A) to the wall 10. On contacting the wall, the difference in refractive indices between the air and the glass causes refraction of the light beam into the wall 10, a shown by the line marked B in FIG. 2a. At the end of arrow B two paths are shown. The left hand arrow, C, shows the case when total internal reflection does not occur. Such a case arises when the difference between refractive indices of the glass and whatever is in the container is small. This situation arises when fragrance is present up to the level of the emitter 10.

Total internal reflection occurs when there is a greater difference between the refractive indices of the wall 10 and the material behind the wall, i.e. in the situation when air is present, meaning that the level of fragrance in the container is below the level of the emitter 14. In this situation the light takes the path shown by arrow D having been totally internally reflected at the air/wall interface. At the end of arrow D, refraction back into the air occurs, as shown by arrow E. Total internal reflection does not occur again because of the different angle of incidence of the arrow D. The light then passes to a sensor 16, chosen to be receptive to the light of the emitter 14, for example it may be photodiode or photoresistor.

Careful selection of the positioning of the emitter 14 must be made in order that light approaching the wall 10 is refracted into the wall 10 at a suitable angle so that the angle of incidence at the head of arrow B results in the light either being totally internally reflected or refracted depending on the presence or non-presence of the fragrance in the container. For this, a difference in refractive index is required between the fragrance and air. In this way, two critical angles will be derivable, one for the glass/air interface and one for the glass/fragrance interface. The angle of incidence of arrow B should be between these two critical angles, so that in one situation there is refraction and in the other there is total internal reflection.

The use of the bulge 12, which is shown in FIGS. 2b and 2c forms a rib along the bottle is useful in allowing the correct angle of incidence of the arrow B with the interface between the interior of the bottle and the bottle contents.

Other relevant factors include the thickness of the glass and the purity of the glass, which if of particularly low quality will result in more light being scattered, rather than the light being retained in a beam. Scattering of light is disadvantageous, because it reduces the amount of light reaching the sensor 16.

As shown in FIGS. 2b and 2c a wick 18 is present in the container in order to transport fragrance to an ejection section of the emanator device, which incorporates a heater 20 to cause evaporation. It is particularly important that the path of light from the emitter 14 to the sensor 16 is not compromised by the presence of the wick 18. Thus, the angle of incidence of the beam of light from the emitter 14 must be selected to avoid the wick 18.

It will be apparent that with the total internal reflection method discussed above, there will always be some residual fragrance remaining the container, as shown in FIG. 2c. A remaining life counting mechanism can be used as a supplementary for use with this method.

The remaining life counting may be based on a time recording with a non-volatile memory (for example EEPROM). When an empty event is reported by the total internal reflection mechanism, consisting of the emitter 14 and sensor 16 and a control portion (not shown), the control portion will activate a timer with a predetermined shut down delay. When the final time is reached, the device will terminate a lighting function, so as to cause lights of the device to cease illuminating and so make a user aware that the device needs attention. Alternatively, the device may be disabled entirely, or a heater may be disabled.

Another method of determining when a container becomes empty is based on a temperature change in the wick 18 shown in FIG. 2c. An emanator section of a fragrance delivery device makes use of the heater 20 in the form of a collar around an upper part of the wick 18. The heater causes evaporation of the fragrance material which then emanates from the device. This evaporation causes more fragrance to be drawn up the wick 18, which is eventually exhausted once the supply of fragrance in the container has been used up.

With a heater 20 with a given heat capacity, the temperature on the wick 18 is dependent on the heat capacity of the wick, or the thermal load on the heater 20. The thermal load on the wick 18 will decrease when it changes from being soaked with fragrance to a dry state. When this happens, the temperature on the wick 18 will increase as a result of the reduced thermal load on the wick 18. The delivery of fragrance during emanation and the evaporation of fragrance from the wick as described above, also require energy from the heater 20, which further reduces the wick temperature.

In order to detect the change in temperature between a fragrance-soaked wick 18 and a dry wick 18, a thermal sensor 22 is placed above the heater 20 and may be attached to a chimney section (not shown) above the heater. The thermal sensor 22 is placed in the vicinity of the wick, but not necessarily in contact therewith. The thermal sensor 22 may be thermocouple or a thermistor.

The thermal sensor 22 should be very small so that its own thermal capacity is correspondingly small, so that the change in temperature can be detected between a wet and a dry wick 18.

It has been found that different fragrances result in different wick temperatures, which may vary up to about 3°, depending on the particular fragrance used. Consequently, it should be borne in mind that that the temperature difference between a wet and dry wick 18 should be greater than the variation between various fragrances (or the difference should be accounted for), but the difference in temperature must also be significant compared with the tolerance of the temperature sensor 22. It has been found that the difference between wet and dry temperatures for the wick 19 is approximately 3 to 5° C.

In order to compensate for the variation between different fragrances one option would be to record (in a non-volatile memory, such as EEPROM) the temperature of the wet wick condition when the device is initially commissioned. This would then allow a comparison to be made with a temperature at regular intervals, to detect when the wick temperature drops to the dry temperature. This would allow the difference in temperature due to the particular fragrance concerned to be removed from consideration.

When the temperature drop is detected between the wet and dry states of the wick 18 the whole emanation device could be switched off, or just lights of the device could be switched off to indicate to a user that the fragrance container should be changed.

Another method of determining the end of life of a fragrance container is to make use of difference in the weight of the bottle between empty and full states. As the fragrance in a container dissipates the weight of the container will reduce. The weight of the empty container and that of the fragrance is well controlled in production. Consequently, the weight change presents an accurate indication of the filling state of the container and hence can be used for empty container detection.

The weight of the container can be measured by two means.

A first is to use a strain gauge which can be use where the container is supported by prongs 30, as shown in FIGS. 3a and 3b. Strain gauges 32 are secured to each of the prongs 30 and are configured as a Wheatstone bridge, as is well known in the art, and the weight change can be determined from the output signal of the Wheatstone bridge. An absolute value for the weight can be determined from the strain gauge if suitably calibrated initially.

An alternative method for measuring the weight of the container is to make use of a quantum tunnelling composite (QTC), which is a force sensitive rubber which has the properties of its resistivity varying with the force it is subjected to. A small piece of QTC could be attached the prongs 30, for example in the location of the strain gauge 32. A current applied to the piece of QTC would have a varying voltage caused by varying force exerted by the bottle. The force would vary as the amount of fragrance in the bottle changed. Thus, when a threshold value for the voltage was achieved (resulting from a weight change of the container) then an end of life program on a control portion (not shown) of the device could be triggered. The end-of-life program may be as described above, and may include lights of a device being turned off, power to the heater 20 being stopped, and/or complete power-down.

The advantage of the change of weight method is that it does not rely on the absolute weight of the device, but rather a change in the weight over a period of time. When the weight periodically changes, it is clear that there is still some fragrance in the container. When the weight ceases decreasing, then it can be assumed that the container is empty or the device has malfunctioned.

It would be possible to combine the two versions mentioned above to obtain an absolute value of the weight of the container (from a suitably calibrated version of the strain gauge arrangement) and also the weight change. Such a method could be used to provide a very reliable signal, in which a combination of the two values is used to reduce errors in the measurement.

As an alternative to suspending the container from the support prongs 30 a bottom sensor could be used. By providing a base on which the container sits changes in the resistivity of the QTC can be detected when a current is passed therethrough, because of changes in the resistivity due to the change in weight experienced when the fragrance is dissipated.

An alternative method by which the end of life for the container could be provided would be to use a timer. A simple counting mechanism with a non-volatile mechanism (e.g. EEPROM) would allow accurate life counting, and hence determine the filling state of a container.

A button could be provided for a user to press to commence a count, so that the user obtains an indication of when the container is exhausted. The indication could be by a time counter which, for example, may count a period of 80 days from the pressing of the switch, when a indication of the container being empty will be provided. 80 days is a reasonable period of time based on the use of a container having 15 to 17 grams of liquid for approximately 12 hours a day.

Of course other time periods could be used based on a size of container and a pattern of use.

An option or addition to the life time count would be to have different life times based on the different intensity settings that are usually provided in a fragrance emanator. For example, a minimum setting may be 80 days, whereas a maximum emanation setting may reduce the life time to approximately 20 days.

The counting is set to count when the fragrance emanator is receiving power, with information as to the state of the count being retained by an EEPROM when powered off. The non-volatile nature of the memory used allows the counts to be retained when no power is being received.

A further end of life indication is provided by the following method which uses refraction of light through a glass container. The system is similar in set-up to the total internal reflection method, but relies only on refraction, rather than a combination of refraction and reflection. Also, this method does not make use of a rib 12 extending down the container, which rib was used in the total internal reflection method. As can be seen from FIGS. 4b and 4c the shape of a container 40 in plan is generally D-shaped, an emitter 14 in the form of a light source, which could be of any of the same types referred to in relation to the total internal reflection method, is located on one side of the curved face of the container 40 and a sensor 16, again of the same type suitable for the total internal reflection method, is placed on the opposite side of the curved face.

As before, the difference between a refractive indices of air and fragrance is used in this approach.

FIG. 4a shows the light path between the light emitter 14 and sensor 16 when no bottle is present. As can be seen the sensor 16 detects light emitted from the emitter 14.

In FIG. 4b the situation of an empty container 40 is shown with the light hitting the curved face of the bottle, being refracted inwards into the interior of the bottle, travelling through air in the bottle to the opposite side of the curved face then being refracted outwards and onto the sensor 16. Consequently, based on the difference in refractive index of the glass and the refractive index of the empty bottle the sensor receives light from emitter 14 when the container 40 is empty.

In FIG. 4c the situation is shown when the container 40 has fragrance in it above the level of the emitter and sensor pair 14/16. As can be seen, the light beam is refracted through the container 40 and passes out of the container 40, but does not reach the sensor 16.

Consequently, the system described in relation to FIGS. 4a to 4c is able to provide a detection of both no container 40 being present in a fragrance emanation device and also an indication of when the level of fragrance in the container falls below a desired level.

The emitter 14 and sensor 16 must be placed above the very base of the container in order that the light passes through the fragrance in the container 40. For this reason, when the empty signal is created by the light shining through the bottle from the emitter 14 to the sensor 16 there will still be a small amount of fragrance in the bottle (as shown in FIG. 2c). In order that the empty signal is not provided immediately, a timer is started when the bottle is first detected as being empty. This is the same as is described in relation to the total internal reflection method and the same timing systems can be used in the refraction method described in relation to FIGS. 4a to 4c.

All of the methods of detecting an end of life of a container for fragrance or sanitising fluid can be used either alone or in combination with one another. When used in combination better accuracy may be achieved. The devices to which these methods and systems can be applied are fragrance emanation devices, sanitising fluid emanation devices and other material ejection devices generally. There is also relevance to spray devices for some of the methods.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An emanation device comprising: an emanation material container, an emanation section and emanation material level indication means; wherein, the emanation material level indication means comprises a light source, a light detector and control means, wherein the light detector is adapted to receive light from the light source when a level of emanation material in the emanation material container is at a first level and wherein the light detector is adapted to receive substantially no light from the light source when a level of emanation material in the emanation material container is at a second level.

2. An emanation device according to claim 1, in which the first level is a level of the emanation material below a sensing level, which is at or close to an empty level.

3. An emanation device according to claim 2, in which the empty level is a nominal empty level below which the emanation material level indication means is not operable to detect.

4. An emanation device according to claim 1, in which the second level is a level of the emanation material substantially at or above the sensing level.

5. An emanation device according to claim 1, in which the light detector is adapted to receive light when either no emanation material container is present in the device or the level of emanation material in the container is below a detection level.

6. An emanation device according to claim 1, in which the light source is adapted to direct light at the emanation material container at an angle that is substantially at or between:
a) a critical angle of incidence for an interface between the emanation material and the emanation material container; and
b) a critical angle of incidence for an interface between air and the emanation material container.

7. An emanation device according to claim 1, in which the sensor is located to receive light from the light source that has entered the emanation material container and has been reflected from the interface between the emanation material container and air in the container.

8. An emanation device according to claim 1, in which the material container incorporates a rib in a wall thereof.

9. An emanation device according to claim 8, in which the rib extends towards an opening of the material container.

10. An emanation device according to claim 8, in which the light source is adapted to direct light towards the rib.

11. An emanation device according to claim 1, in which the sensor is located to receive light from the light source that has entered the emanation material container and has been refracted at the interface between the emanation material container and air in the container.

12. An emanation device according to claim 11, in which the sensor is arranged in relation to the light source such that light is refracted away from the detector when emanation material in the container is present at a detection level.

13. An emanation device according to claim 1, in which the light source and light detector are in line-of-sight of one another, in order to allow light detection when no emanation material container is present.

14. An emanation device according to claim 1, in which the control means are operable to control a light or lights of the emanation device.

15. An emanation device as claimed in any preceding claim, in which the control means are operable to control a heater of the emanation device.

16. An emanation device according to claim 1, in which includes a temperature sensor, adapted to sense a temperature of a wick of the emanation device.

17. An emanation device according to in claim 16, in which is operable to sense a difference in temperature that occurs when there is insufficient emanation material in the emanation material container for the wick to transport the emanation material to the emanation section.

18. An emanation device according to claim 16, in which the temperature sensor is operable to sense a difference in temperature of the wick between a wet condition of the wick and a dry condition thereof.

19. An emanation device according to claim 1, which includes weight sensing means.

20. An emanation device according to claim 19, in which the weight sensing means are operable to sense weight, or a change in weight, of the emanation material container.

21. An emanation device according to claim 19, in which the weight sensing means include at least one strain gauge

22. An emanation device according to claim 19, in which the control means is operable to receive signals from the weight sensing means.

23. An emanation device according to claim 19, in which the weight sensing means incorporate a material having a variable electrical resistivity dependent on a strain applied to the material.

24. An emanation device according to claim 19, in which the control means are adapted to detect an end-of-life of the emanation material container when the weight of the emanation material container, and any emanation material therein, has fallen below a threshold level.

25. An emanation device according to claim 1, which includes a counting element operable to count a life span of the emanation device based on use thereof.

26. An emanation device according to claim 25, in which the counting element is operable to count to a preset time limit when the emanation device is receiving power for emanation of the emanation material.

27. An emanation device according to claim 24, in which the counting element is actuable by a user to commence a count time.

28. An emanation material container adapted to be used with an emanation section and emanation material level indication means of an emanation device according to claim 1.

29. (canceled)
